(19) United States
(12) Patent Application Publication
(10) Pub. No.: US 2020/0191368 A1
(43) Pub. Date: Jun. 18, 2020

(54) Built in pop up 360 degree swivel tri-LED light for smartphone/tablet

(71) Applicant: Toniesha Teshell Reed, Las Vegas, NV (US)

(72) Inventor: Toniesha Teshell Reed, Las Vegas, NV (US)

(21) Appl. No.: 16/716,520

(22) Filed: Dec. 17, 2019

Related U.S. Application Data
(60) Provisional application No. 62/781,081, filed on Dec. 18, 2018.

(51) Int. Cl. F21V 21/26; G06F 1/16; F21V 33/00

(52) U.S. Cl. CPC F21V 21/26; G06F 1/1626; F21Y 2115/10; F21V 33/0052; G06F 1/1656

(57) ABSTRACT

Built in 360 degree swivel tri-LED light for smartphone/tablet is disclosed. By providing more than 3 times the illumination that the standard LED on most smartphones, this will be the ultimate lighting for front and back photos and videos on a smartphone/tablet. Adding sufficient light produces superior photos and videos.

### BACKGROUND OF THE INVENTION

### Problem Solved

Shooting HD video footage on smartphones in low light. Situations yield poor results. Carrying extra external parts for lighting is cumbersome and inconvenient.

The invention claimed here solves this problem.

Shooting HD video footage on smartphones in low light situations yields poor results. Taking selfportraits (selfies) on smartphones in low light situations yields poor results.

By providing more than 3 times the illumination that the standard LED on most smartphones, this will be the ultimate lighting for front and back photos and videos on a smartphone/tablet. Adding sufficient light produces superior photos and videos.

### DETAILED DESCRIPTION OF THE INVENTION

As stated above, shooting HD video footage on smartphones in low light situations yield poor results.

Carrying extra external parts for lighting is cumbersome and inconvenient. The invention claimed here solves this problem.

By being built into the smartphone/tablet, extra lighting is conveniently at your fingertips. High output, low power LED lights built into the smartphone would provide the necessary light for satisfactory video recording. A 360 swivel and tilting base will provide sufficient lighting for self-portraits photos/videos and photography and videography at any angle from smartphone/tablet.

The claimed invention differs from what currently exists. As stated above, shooting HD video footage on smartphones in low light situations yields poor results. Taking self-portraits (selfies) on smartphones in low light situations yields poor results. Carrying extra external parts for lighting is cumbersome and inconvenient. The invention claimed here solves this problem.

This invention is an improvement on what currently exists. As stated above, shooting HD video footage on smartphones in low light situations yields poor results. Taking self-portraits (selfies) on smartphones in low light situations yields poor results. Carrying extra external parts for lighting is cumbersome and inconvenient. The invention claimed here solves this problem.

In photography and videography, no lights equals bad pictures and bad videos.

By providing more than 3 times the illumination that the standard LED on most smartphones, this will be the ultimate lighting for front and back photos and videos on a smartphone/tablet. Adding sufficient light produces superior photos and videos.

### THE VERSION OF THE INVENTION DISCUSSED HERE INCLUDES

1. Light source
2. Casing
3. Pop-up/swivel part

Relationship Between the Components:

The casing (#2) holds the light source (#1) and is ejected and activated when casing is depressed. Casing raises up on pop-up/swivel part (#3) and rotates for forward or rear camera illumination. Pressing casing multiple times activates LEDs 2 and 3 respectively to increase or decrease light intensity. Also functions as an extra strobe flash when used with camera app on smartphones and tablets. The included app that controls the extra device will also have the ability to turn the entire phone/tablet screen into ambient lighting in any color, to provide additional white light or colored ambient lighting for photography and video recording.

### HOW THE INVENTION WORKS

The built in light activates when the casing is depressed. Pressing multiple times cycles through the

modes of the light source. First press is 1 LED, 2 presses is 2 LEDs, 3 presses is 3 LEDs, 4 presses is flash mode, and 5 presses is OFF. Casing can swivel 360 degrees and tilt 30 degrees in any direction on popup/swivel part. IF depressed THEN casing pops up and light source activates.

IF depressed again THEN 2nd LED illuminates.

IF depressed again THEN 3rd LED illuminates.

IF depressed again THEN flash mode enabled for camera app.

(5-way toggle switch).

### HOW TO MAKE THE INVENTION

Design and mold parts. Manufacture components and connect electrical pieces and circuitry. Add seal to ensure mechanism remains air tight and waterproof both while in use and stored in device. Then release specifications to smartphone designers to be built into all smartphones and tablet designs.

All parts are necessary. Stronger components and high quality materials will make the invention work better.

The design can be changed from built-in/pop up to build on/flip up casing (phone/tablet cases). The toggle switch can be changed to a roller knob (potentiometer). The triple LED light source can be changed to any numbers of LEDs that can be built into casing and phone. The LEDs can be changed to multicolored LEDs and be changeable through mobile app.

### HOW TO USE THE INVENTION

When taking pictures or shooting video in low light situations, activate invention (depress casing) for additional light. If more light is needed, depress casing again. Up to 3 times for constant light. Press 4 times for flash mode. Press once more to turn LEDs off. For forward camera light, turn casing 180 degrees toward you.

Additionally: This invention can be used for any application or device that utilizes a LEDs light source. (I.e. flashlight).

### BRIEF DESCRIPTION OF THE DRAWINGS

FIG. 100 is a view of pop up 360 degree swivel tri-LED light.

FIG. 200 shows use of pop up 360 degree swivel tri-LED light in smartphone.

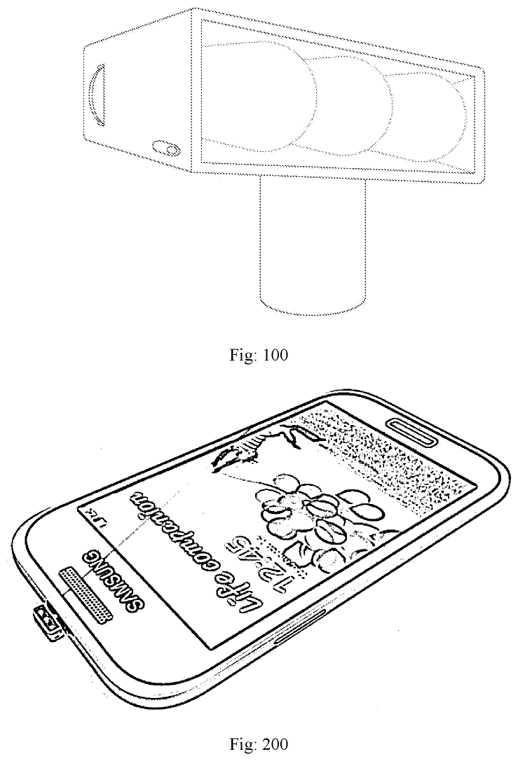

1) The claimed invention being built into the smartphone/tablet, in which casing holds the light source and is ejected and activated when casing is depressed, casing raises up on pop-up/swivel part and rotates for forward or rear camera illumination.

2) The claimed invention being built into the smartphone/tablet, extra lighting is conveniently at user fingertips and would provide the necessary light for satisfactory video recording.

3) 3 times the illumination that the standard LED on most smartphones, this will be the ultimate lighting for front and back photos and videos on a smartphone/tablet, adding sufficient light produces superior photos and videos.
